(19) United States
(12) Patent Application Publication
(10) Pub. No.: US 2008/0156742 A1
(43) Pub. Date: Jul. 3, 2008

(54) Sludge Reduction System for Wastewater Treatment

(75) Inventors: Jack L. McCrea, Pittsburgh, PA (US); Stephen P. Markle, Alexandria, VA (US); Randall J. Jones, Scottsdale, AZ (US)

Correspondence Address: VENABLE, CAMPILLO, LOGAN & MEANEY, P.C., 1938 E. OSBORN RD, PHOENIX, AZ, 85016-7234, US

(73) Assignee: NAVALIS ENVIRONMENTAL SYSTEMS, LLC

(21) Appl. No.: 11/616,398

(22) Filed: Dec. 27, 2006

(51) Int. Cl. C02F 1/78

(52) U.S. Cl. 210/760; 210/205

(57) ABSTRACT

A sludge reduction system that reduces the volume of solids contained in a fluid medium such as a wastewater stream. The system reduces the disposal burden and reduces odors by oxidizing organic material such as raw or activated sludge in an ozone oxidation zone and then separating the concentrated sludge for extraction in a concentrated sludge extraction zone. The sludge reduction system is particularly useful in applications such as cruise ships because (1) the reduction of sludge saves space and energy costs, and (2) the reduction of odors permits shipboard treatment rather than holding in tanks for later discharge.

### BACKGROUND OF THE INVENTION

1. Field of the Invention

The present invention relates generally to wastewater treatment systems, and more particularly to improved sludge reduction for wastewater treatment systems.

2. Discussion of the Related Art

Many of today's wastewater treatment systems produce large volumes of sludge (raw, activated, and reacted) as a process byproduct. On a cruise ship, for example, this sludge is typically 1-5% solids by weight. Currently, this sludge is (1) pumped overboard into the sea, (2) further processed by dewatering (e.g., press or centrifuge) and/or drying for incineration, or (3) pumped to a shore receiving facility. These current methods of treating sludge have known disadvantages.

Pumping overboard into the sea is limited by local and international laws which may require the ship to alter course or plan in advance a course that will position it for discharging sludge. Pumping overboard will require a holding tank of significant size, pumps, valves and piping. Sludge holding tank may require aeration blowers and the holding tank and discharge pumps, valves and piping may require significant maintenance. Future regulations may limit or eliminate sludge discharge.

Dewatering equipment requires frequent maintenance and current methods produce objectionable odors during the process. A great deal of energy is required to dry this material for incineration due to the low solids concentration. A consequence of drying this material is production of objectionable odors that limit the operation of these type systems.

Dryers are large, heavy and require significant amounts of energy to operate. They also require operator attention and routine maintenance. Dryers must be properly designed and installed to minimize production of objectionable odors.

Holding sludge onboard for later pumping offshore requires large holding tanks, pumps, valves, level control, piping and possibly aeration blowers. The tanks and equipment require routine maintenance and operator attention.

Wastewater treatment systems have been disclosed in the following United States or foreign patents: U.S. Pat. No. 3,822,786 (Marschall), U.S. Pat. No. 3,945,918 (Kirk), U.S. Pat. No. 4,053,399 (Donnelly et al.), U.S. Pat. No. 4,072,613 (Alig), U.S. Pat. No. 4,156,648 U.S. Pat. No. (Kuepper), U.S. Pat. No. 4,197,200 (Alig), U.S. Pat. No. 4,214,887 (van Gelder), U.S. Pat. No. 4,233,152 (Hill et al.), U.S. Pat. No. 4,255,262 (O'Cheskey et al.), U.S. Pat. No. 4,961,857 (Ottengraf et al.), U.S. Pat. No. 5,053,140 (Hurst), U.S. Pat. No. 5,178,755 (LaCrosse), U.S. Pat. No. 5,180,499 (Hinson et al.), U.S. Pat. No. 5,256,299 (Wang et al.), U.S. Pat. No. 5,308,480 (Hinson et al.), U.S. Pat. No. 6,811,705 (Puetter), EPO 261822 (Garrett), WO 93/24413 (Hinson) and U.S. Pat. No. 6,195,825 (Jones). None of these references, however, disclose the aspects of the current invention.

### SUMMARY OF THE INVENTION

The invention is summarized below only for purposes of introducing embodiments of the invention. The ultimate scope of the invention is to be limited only to the claims that follow the specification.

The invention is incorporated in a sludge reduction system (the “sludge reduction system”) that reduces the volume of solids contained in a fluid medium such as a wastewater stream. The system reduces the disposal burden and reduces odors by oxidizing organic material such as raw or activated sludge in an ozone oxidation zone and then separates the concentrated sludge for removal in a concentrated sludge extraction zone. Among other things, the sludge reduction system is particularly useful in applications such as cruise ships because (1) the reduction of sludge saves space and energy costs, and (2) the reduction of odors makes shipboard treatment by incineration and/or drying less objectionable for passengers than under current systems.

One advantage of the sludge reduction system is that it increases solids concentration through thickening. Experiments have shown increased solids concentrations from a starting range of 1-5% solids (by weight) to a concentrated reacted sludge in the range of 10-15%.

Another advantage of the sludge reduction system is that it produces a reacted sludge of higher viscosity and lower in biosolids that is easier to process.

Another advantage of the sludge reduction system is that it reduces sludge volume at higher solids concentration, requiring less energy and processing for disposal by incineration, reducing the size of treatment equipment (equipment, tanks, etc . . . ), and reducing the shipboard tankage needed to collect, handle, treat and transfer sludge.

Another advantage of the sludge reduction system is that it reduces sludge disposal costs from that for traditional systems, in some case upwards of 50%.

Another advantage of the sludge reduction system is that it reduces objectionable odors from sludge, producing a dark (almost black) reacted material.

Another advantage of the sludge reduction system is that it enables the use of smaller sludge treatment equipment and handling systems.

The description of the invention that follows, together with the accompanying drawings, should not be construed as limiting the invention to the example shown and described, because those skilled in the art to which this invention pertains will be able to devise other forms thereof within the ambit of the appended claims.

### BRIEF DESCRIPTION OF THE DRAWINGS

FIG. 1 illustrates a flow diagram of the preferred embodiment of the sludge reduction system.

FIG. 2 illustrates an overview of the preferred embodiment of the sludge reduction system.

FIG. 3a illustrates an embodiment of the second vessel 42 after the reacted material 50 has entered the second vessel 42.

FIG. 3b illustrates the stratification of an embodiment of the second vessel 42 after quiescent period.

FIG. 4a illustrates a plan view of an embodiment for a sludge reduction system for treating approximately 40 m³/day.

FIG. 4b illustrates an end elevation of the embodiment for a sludge reduction system for treating approximately 40 m³/day.

FIG. 4c illustrates a front elevation of an embodiment for a sludge reduction system for treating approximately 40 m³/day.

### DESCRIPTION OF THE PREFERRED EMBODIMENT

The descriptions below are merely illustrative of the presently preferred embodiments of the invention and no limitations are intended to the detail of construction or design herein shown other than as defined in the appended claims.

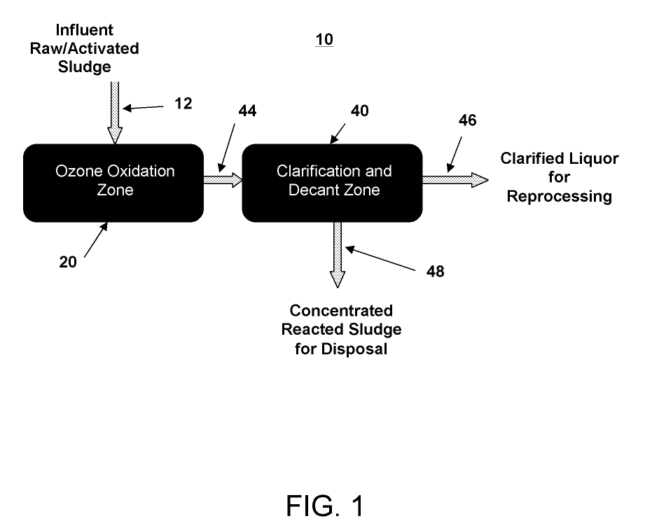

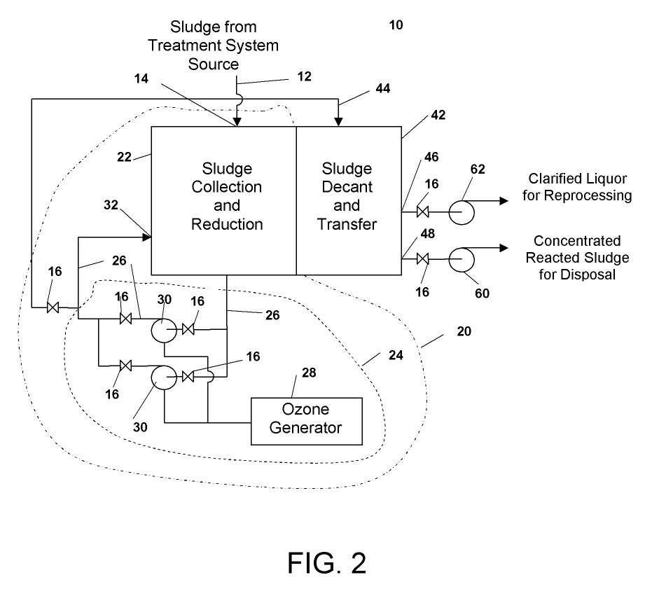

As shown in FIGS. 1 and 2, the sludge reduction system 10 relies on two principle zones: an ozone oxidation zone 20 and a concentrated sludge extraction zone 40. In the preferred embodiment, the ozone oxidation zone 20 comprises a first vessel 22 for holding sludge and an ozone infusing subsystem 24. The ozone infusing subsystem 24 preferably comprises a recirculation line 26, an ozone generator 28 and at least one ozone dissolving pump 30 for infusing ozone into the sludge in the first vessel 22. The first vessel 22 can be most any shape. The size of the first vessel 22 will depend on the volume of sludge to be treated. It is preferred that the first vessel 22 be constructed from 316L stainless steel.

In the preferred embodiment, the concentrated sludge extraction zone 40 comprises a second vessel 42. The second vessel 42 preferably comprises an ozonated sludge inlet 44, a clarified liquor outlet 46, and a concentrated sludge outlet 48. It is preferred to locate the ozonated sludge inlet 44 above the highest expected liquid level or in the top with a pipe to direct it to the proper level. It is preferred to locate the clarified liquor outlet 46 about ⅓ of the height of the second vessel above the bottom. It is preferred to locate the concentrated sludge outlet 48 close to the bottom of the second vessel.

Wastewater is directed and held in various stages by the use of gates or valves 16. Those in the art can place the valves 16 at various locations as needed. It is preferred to locate the valves 16 as shown in FIG. 2. It is also preferred to operate the valves 16 by use of a programmable logic controller (or “system PLC”). In fact, it is preferred to control the entire sludge reduction system through the use of a system PLC.

In operation, influent 12 (e.g., raw or activated sludge) first enters the ozone oxidation zone 20 at a sludge inlet 14. Typically, influent 12 would be expected to be 1-6% solids by weight, with the rest being wastewater. Next, the ozone generator 28 distributes ozone to the ozone dissolving pump 30. The ozone dissolving pump 30 dissolves ozone from ozone generator 28 into vessel effluent flowing through the recirculation line 26. It is preferred to have a pair of ozone dissolving pumps 30 for maintenance purposes. After passing through an ozone dissolving pump 30, vessel effluent (now ozonated) re-enters the ozone oxidation zone 20 at a recirculation inlet 32.

The system continuously accepts influent 12 and it continuously re-circulates ozone infused wastewater via the ozone infusing subsystem 24 for a set period of time, preferably two hours. Experimental trials and observation indicate that 2 hours of hydraulic residence time in the ozone oxidation zone 20 is adequate time to satisfactorily react the sludge. Those in the art will recognize that the design residence time will vary depending on design conditions. In the ozone oxidation zone 20, ozone dissolved in wastewater oxidizes organic carbon material, effectively reducing the volume of solids to carbon dioxide, water and other material.

After the design residence time has been achieved the ozone supply from the generator 28 is stopped, valves 16 are repositioned and the reacted sludge is transferred from the first vessel 22 to the second vessel 42 using the ozone dissolving pumps 30 through the ozonated sludge inlet 44.

After the preset amount of reacted material 50 is moved to the second vessel 42 it forms a concentrated sludge extraction zone 40. Once in the concentrated sludge extraction zone 40, the reacted material 50 is allowed to rest in a quiescent state where clarification by gravity occurs. It is preferred to allow the reacted material to clarify as long as possible while the ozone infusing system 24 is operating in the first vessel 22.

Observation of this process has revealed that reacted material 50, which is organic sludge material from the ozone oxidation zone that has been oxidized with dissolved ozone gas as described previously), will settle to the bottom of the second vessel 42 as concentrated sludge 56, leaving a clarified middle 54 with small amount of floating material 52 on top (some foam, positively buoyant material like bits of wood or plastic, etc.). Experimental trials and observation indicate that a minimum of 45 minutes of residence time is required to settle the concentrated sludge 56.

Clarified liquor 46 from the clarified middle 54 can be re-introduced into the larger treatment system. It has been found that 40-50% of the clarified middle 54 can be decanted back to the beginning of the process. The concentrated sludge 48 and floating material 50 is then removed for disposal via method of choice (for a ship this may be incineration).

An ozone gas destruction system 70 is provided to decompose residual ozone gas to oxygen through catalytic action. Using a blower 71 this system draws a slight vacuum from the top of tanks 22 and 42 and draws the gases through an ozone destruct device 72 before discharging into an installed ventilation system.

In order to size a sludge reduction system for a particular application, one must first determine the system flow requirements. Next, design residence time in each zone (i.e. the ozone oxidation zone 20 and the concentrated sludge extraction zone 40) will dictate the vessel size needed for each zone.

Pumps are sized by system flow volume. Ozone generator is sized based upon volume of sludge to be reacted. Some influent solids variability is expected, so the system will be “tuned” (decant cycle) to actual conditions during the “grooming” phase of the installation. This process will incorporate known system daily fluctuations of influent concentrations. All material used for fabrication of vessels and components should be ozone resistant, such as 316L Stainless Steel.

For example, to treat 40 m³/day of influent sludge the following principle components would be preferred:

1. 7.5 m³ first vessel 22

2. 3.5 m³ second vessel 42

3. 30 gram/hour ozone generator 28 (Pacific Ozone Model Super SGA 22, for example, or equivalent)

4. 6.8 m³/hr Ozone Dissolving Pumps 30 (Nikuni Model M40NP, for example, or equivalent—one or two depending upon redundancy considerations)

5. Concentrated Sludge Discharge Pump 60 (Eddy 6.0³/hr Positive Displacement, for example, or equivalent)

6. Recovered Water Pump 62 (Goulds 2ST1G5C5, for example, or equivalent)

From prior testing, the sludge reduction system 10 is expected to reduce total solids by about 10% (comparing what entered the system and what left the system). In addition, after about 20 minutes of quiescent time in the concentrated sludge extraction zone 40, the second vessel 42 stratifies into three zones: light foam and floaters on top, clarified liquor in the center, and solids that have settled to the bottom. 40-50% of the clarified center section would be able to be decanted back to the wastewater treatment system. At the end of the decant process, the remaining solids would then be pumped to the sludge disposal system for destruction, or disposal.

In order to operate the sludge reduction system, the following steps are preferred:

1. Turn System On.

2. Permit influent 12 (i.e., raw or activated sludge) to enter the ozone oxidation zone 20.

3. Provide power to pumps 30 and system PLC. Provide power and compressed oil free air at sufficient quantity and pressure to operate ozone infusing subsystem 24.

4. Enable system PLC to move reacted material 50 from ozone oxidation zone 20 to concentrated sludge extraction zone 40 at desired intervals.

5. Provide means to transfer both clarified liquor 46 and concentrated sludge 48 for further treatment/disposal.

In an alternate embodiment of the sludge reduction system (a “batch embodiment”), the ozone oxidation zone 20 and the concentrated sludge extraction zone 40 are located in the same tank (or vessel). In this embodiment, a single tank is used and solids are treated in a controlled sequence of steps, similar to the cycles of a washing machine. In the first step, solids are introduced and ozonated as before in an ozone oxidation zone 20. After a set period of time, generally about 2-hours, the ozone recirculation flow is stopped and the material is allowed to go quiescent for a set time, generally 45 minutes. This step allows for solids settling as described before. Next the clarified liquid is decanted off, followed by pump out of remaining reacted and thickened solids. At the conclusion of solids removal, a new batch of material is introduced into the tank and the process begins anew.

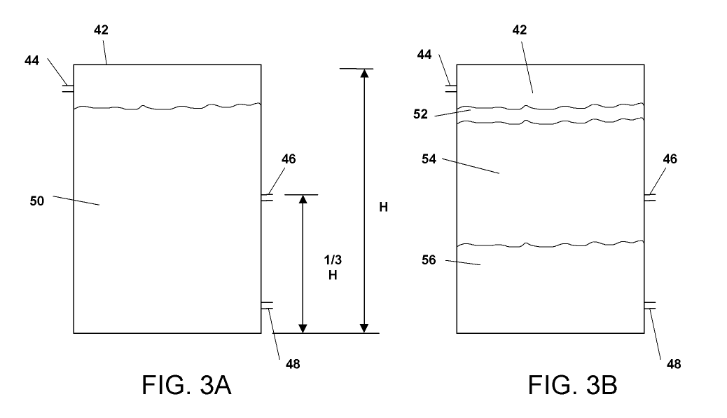

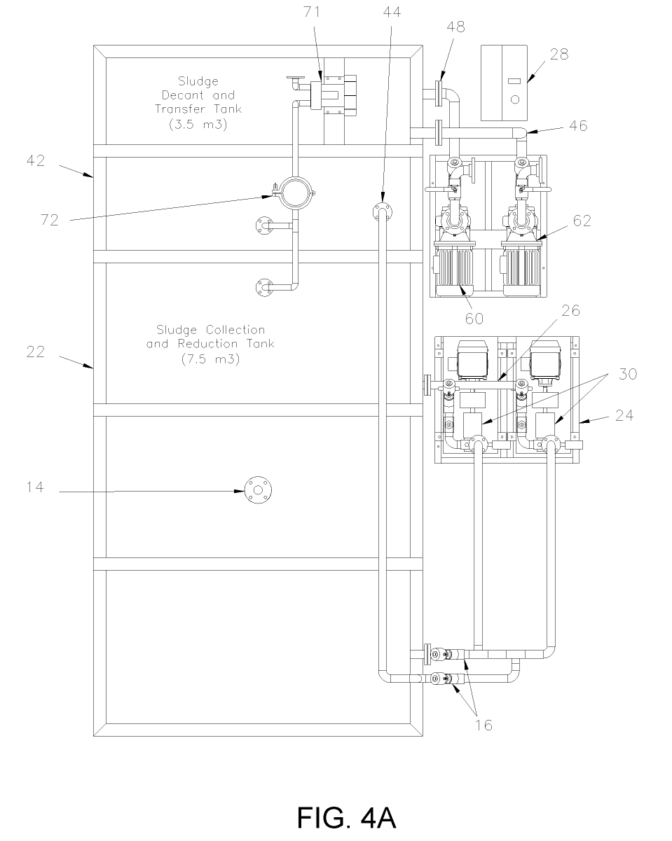

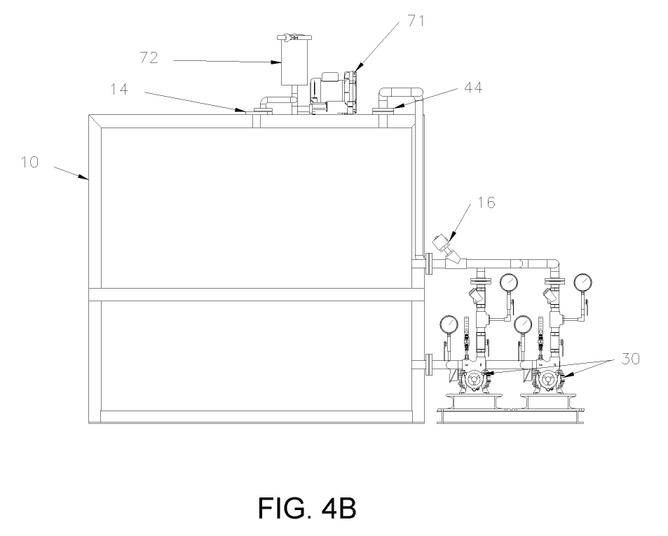

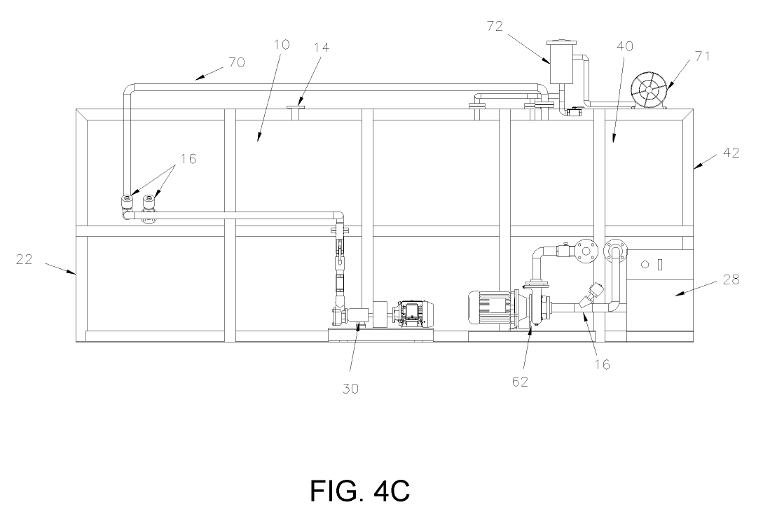

Similarly, another embodiment of the sludge reduction system illustrated in FIGS. 1-4 would employ more than one second vessel 42 to service a large advanced oxidation zone 20.

Users of the sludge reduction system include any fluid system where reduction in organic solids is desirable to ease the disposal burden. Potential users of the sludge reduction system include ship operators (i.e. cruise ships, military, cargo), land based wastewater treatment systems, food industry, chemical industry, etc.

Although the invention has been described in detail with reference to one or more particular preferred embodiments, persons possessing ordinary skill in the art to which this invention pertains will appreciate that various modifications and enhancements may be made without departing from the spirit and scope of the claims that follow.

What is claimed is:

1. A sludge reduction system for use in a wastewater treatment process, the sludge reduction system comprising:
an ozone oxidation zone and a concentrated sludge extraction zone, wherein the ozone oxidation zone is in periodic fluid communication with the concentrated sludge extraction zone at an ozonated sludge inlet,
the ozone oxidation zone comprising a first vessel and an ozone infusing subsystem connected to the first vessel, the ozone infusing subsystem comprising a recirculation line, an ozone generator and an ozone dissolving pump,
the concentrated sludge extraction zone comprising a second vessel the second vessel comprising the ozonated sludge inlet, a clarified liquor outlet, and a concentrated sludge outlet.

2. A sludge reduction system for use in a wastewater treatment process, the sludge reduction system comprising:
a ozone oxidation zone, the ozone oxidation zone comprising an ozone generator and an ozone dissolving pump, and a
concentrated sludge reduction zone, the concentrated sludge reduction zone comprising a first outlet to remove a bottom strata of sludge and a second outlet to remove a middle strata of clarified liquor.

3. A method for treating wastewater comprising the acts (steps) of:
separating sludge during the wastewater treatment process,
transferring the separated sludge to an ozone oxidation zone,
dissolving ozone into effluent from the ozone oxidation zone,
recirculating ozonated effluent back into the ozone oxidation zone,
transferring a treated sludge from the ozone oxidation zone to a concentrated sludge extraction zone,
extracting a concentrated sludge from the bottom strata of the concentrated sludge reduction zone,
extracting a clarified liquor from the middle strata of the concentrated sludge reduction zone.

4. The method for treating wastewater of claim 3, wherein the concentrated sludge is treated further by a process selected from the group consisting of drying, incinerating or discharging.

5. The method for treating wastewater of claim 3, wherein the clarified liquor is re-circulated back into the wastewater treatment process for additional treatment.

6. A sludge reduction system for use in a wastewater treatment process, the sludge reduction system comprising:
an ozone oxidation zone and a concentrated sludge extraction zone, wherein the ozone oxidation zone and the concentrated sludge extraction zone are located in a first vessel,
the ozone oxidation zone further comprising an ozone infusing subsystem connected to the first vessel, the ozone infusing subsystem comprising a recirculation line, an ozone generator and an ozone dissolving pump,
the concentrated sludge extraction zone further comprising a clarified liquor outlet and a concentrated sludge outlet connected to the first vessel.
